(19) United States
(12) Patent Application Publication
(10) Pub. No.: US 2026/0140587 A1
(43) Pub. Date: May 21, 2026

(54) INFORMATION PROCESSING APPARATUS, INFORMATION PROCESSING METHOD, AND NON-TRANSITORY RECORDING MEDIUM

(71) Applicant: PFU LIMITED, Kahoku-shi (JP)

(72) Inventor: Tomoaki Wada, Kahoku-shi (JP)

(21) Appl. No.: 19/382,958

(22) Filed: Nov. 7, 2025

(30) Foreign Application Priority Data
Nov. 15, 2024 (JP) 2024-199716

(51) Int. Cl. G06F 3/041; G06F 3/01; G06F 3/04886

(52) U.S. Cl. CPC G06F 3/04166; G06F 3/013; G06F 3/0418; G06F 3/04886; G06F 2203/04803

(57) ABSTRACT

An information processing apparatus includes a first operation portion to receive a first operation to start a predetermined process, a second operation portion to receive a second operation and to be controlled to change a display mode, and control circuitry to control the second operation portion to display a predetermined display when a state of the information processing apparatus satisfies a start condition for starting the predetermined process and does not satisfy a prevention condition for preventing execution of the predetermined process.

### CROSS-REFERENCE TO RELATED APPLICATIONS

This patent application is based on and claims priority pursuant to 35 U.S.C. §119(a) to Japanese Patent Application No. 2024-199716, filed on November 15, 2024, in the Japan Patent Office, the entire disclosure of which is hereby incorporated by reference herein.

### BACKGROUND

The present disclosure relates to an information processing apparatus, an information processing method, and a non-transitory recording medium.

An image processing apparatus that includes an operation device including a first operation portion and a second operation portion is proposed. In this image processing apparatus, the first operation portion includes a touch-screen display and a home key that is a hardware key, and the second operation portion includes a power key and an energy saving key that are hardware keys, and a light-emitting diode (LED) lamp.

### SUMMARY

The information processing apparatus according to one aspect of the present disclosure includes a first operation portion to receive a first operation to start a predetermined process, a second operation portion to receive a user operation and to be controlled to change a display mode, and control circuitry. The control circuitry controls the second operation portion to display a predetermined display when a state of the information processing apparatus satisfies a start condition for starting the predetermined process and does not satisfy a prevention condition for preventing execution of the predetermined process.

The information processing method according to another aspect of the present disclosure is performed by an apparatus including a first operation portion that receives a first operation to start a predetermined process, and a second operation portion that receives a user operation and is controlled to change a display mode. The information processing method includes controlling the second operation portion to display a predetermined display when a state of the apparatus satisfies a start condition for starting the predetermined process and does not satisfy a prevention condition for preventing execution of the predetermined process.

The computer-readable, non-transitory medium storing a computer program according to still another aspect of the present disclosure causes an information processing apparatus including a first operation portion that receives a first operation to start a predetermined process, and a second operation portion that receives a user operation and is controlled to change a display mode, to execute a process. The process includes controlling the second operation portion to display a predetermined display when a state of the apparatus satisfies a start condition for starting the predetermined process and does not satisfy a prevention condition for preventing execution of the predetermined process.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an information processing apparatus;

FIG. 2 is a diagram illustrating a conveying path inside an information processing apparatus;

FIG. 3 is a block diagram illustrating a schematic configuration of an information processing apparatus;

FIG. 4 is a block diagram illustrating a schematic configuration of a memory and a processing circuit;

FIG. 5 is a flowchart of a setting process;

FIGS. 6A and 6B are schematic each diagrams illustrating a first display and operation device and a second display and operation device;

FIGS. 7A and 7B are schematic diagrams each illustrating a first display and operation device and a second display and operation device;

FIG. 8 is a flowchart of a medium reading process;

FIGS. 9A and 9B are schematic diagrams each illustrating a first display and operation device and a second display and operation device;

FIG. 10 is a flowchart of a multi-feed determination process;

FIG. 11 is a flowchart of a display control process;

FIGS. 12A and 12B are schematic diagrams each illustrating another guidance display;

FIGS. 13A and 13B are schematic diagrams each illustrating still another guidance display; and

FIG. 14 is a diagram illustrating a schematic configuration of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing method, and a control program are described below with reference to the drawings. The technical scope of the present disclosure is not limited to the embodiments described below and covers equivalents of the elements described below.

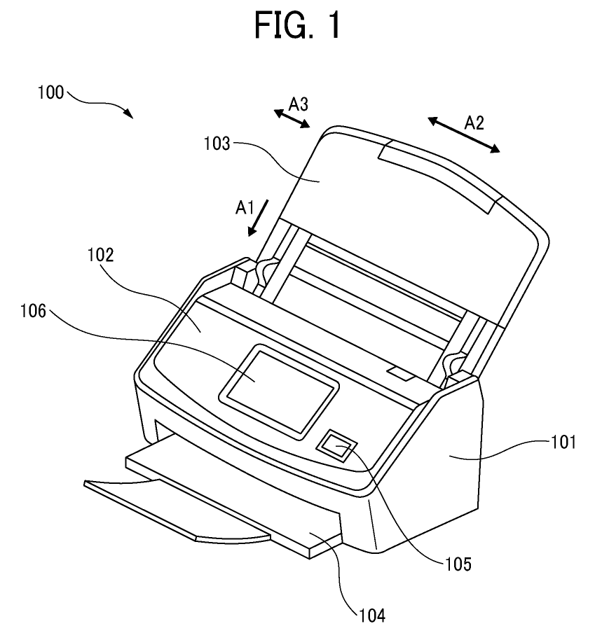

FIG. 1 is a perspective view of an information processing apparatus 100, which is an image scanner.

The information processing apparatus 100 conveys, images, and ejects a medium that is a document. Examples of the media include paper, thick paper, cards, booklets, and passports. Other examples of the information processing apparatus 100 include a facsimile machine, a copier, and a multifunction peripheral (MFP).

In FIG. 1, arrow A1 indicates the direction in which a medium is conveyed (also “medium conveying direction A1”), arrow A2 indicates the width direction perpendicular to the medium conveying direction A1, and arrow A3 indicates the height direction perpendicular to a medium conveying path. In the following, upstream is upstream in the medium conveying direction A1, and downstream is downstream in the medium conveying direction A1. The width direction A2 is an example of a direction intersecting the medium conveying direction A1.

The information processing apparatus 100 includes a lower housing 101, an upper housing 102, a media tray 103, an ejection tray 104, a first display and operation device 105, and a second display and operation device 106.

The upper housing 102 is located to cover the upper side of the information processing apparatus 100 and hinged to the lower housing 101 such that the upper housing 102 is opened and closed, for example, to remove a jammed medium or clean the inside of the information processing apparatus 100.

The media tray 103 is engaged with the lower housing 101. Media to be fed and conveyed are placed on the media tray 103. The ejection tray 104 is engaged with the lower housing 101, and the ejected media are stacked thereon. The ejection tray 104 may be engaged with the upper housing 102 with a hinge or the like.

The first display and operation device 105 is an example of a first operation portion. The first display and operation device 105 includes an input device, such as a mechanical button, and an interface circuit that receives signals from the input device. The first display and operation device 105 receives an operation input by a user and outputs a signal corresponding to the input operation. The first display and operation device 105 receives a start operation (a first operation) and an end operation performed by a user to initiate a predetermined process and end the predetermined process. The use of a mechanical button as the first display and operation device 105 allows the user to easily perform the start operation for the predetermined process. Thus, the information processing apparatus 100 enhances the convenience of the user. The predetermined process is a process performed by the information processing apparatus 100 according to an operation on the first display and operation device 105 performed by the user. For example, the predetermined process includes the reading of a medium. The user can easily perform the start operation for reading the medium using the first display and operation device 105, and the information processing apparatus 100 enhances the convenience of the user.

The first display and operation device 105 includes an output device, such as a light-emitting diode (LED), and an interface circuit that controls the output device. The first display and operation device 105 can change the display mode by turning on and off the light of the output device or changing the brightness or color of light emitted by the output device according to an instruction from a processing circuit described later. The change of the display mode of the first display and operation device 105 allows the user to recognize the state of the information processing apparatus 100 at the position where the start operation and the end operation for the predetermined process are performed. Thus, the information processing apparatus 100 enhances the convenience of the user.

The second display and operation device 106 is an example of a second operation device. The second display and operation device 106 includes an input device, such as a touch screen, and an interface circuit that receives signals from the input device. The second display and operation device 106 receives an operation input by the user and outputs a signal corresponding to the input operation. The second display and operation device 106 receives a setting operation (a second operation) performed by the user. The use of a touch screen as the second display and operation device 106 allows the user to easily perform various setting operations. Thus, the information processing apparatus 100 enhances the convenience of the user.

The second display and operation device 106 includes an output device and an interface circuit that outputs image data to the output device, and displays the image data on the display. Examples of the display include a liquid crystal display and an organic electro-luminescence (EL) display. The second display and operation device 106 changes the display mode by changing the information displayed on the display according to an instruction from the processing circuit. The change of the display mode of the second display and operation device 106 allows the user to recognize the state of the information processing apparatus 100 at the position where the setting operation is performed. Thus, the information processing apparatus 100 enhances the convenience of the user.

The first display and operation device 105 and/or the second display and operation device 106 may separately include a display device and an operation device. The first display and operation device 105 may include, for example, a touch screen and a display instead of the mechanical buttons and the LED. The second display and operation device 106 may include, for example, a mechanical button and an LED instead of the touch screen and the display.

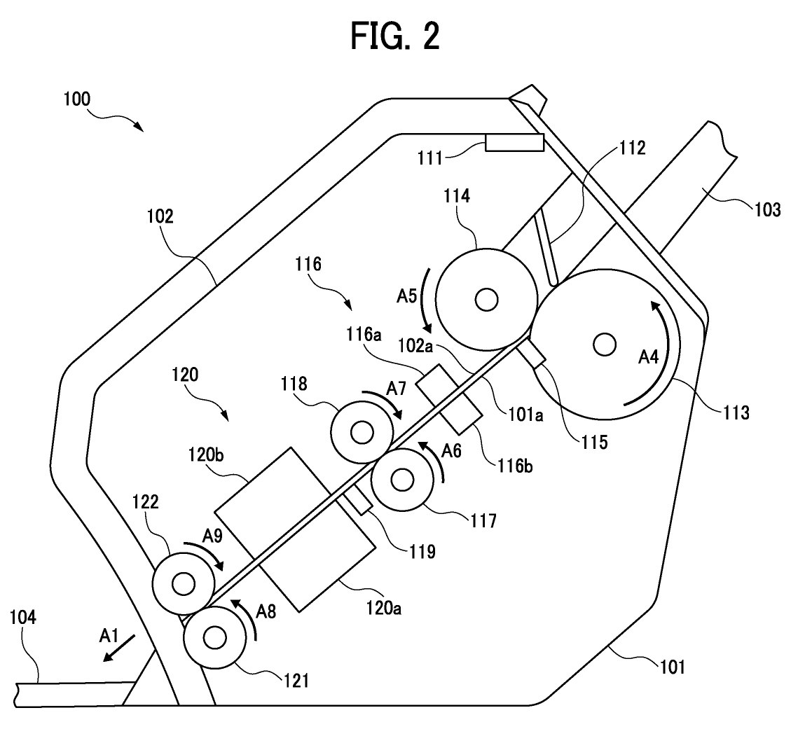

FIG. 2 is a diagram illustrating a conveying path inside the information processing apparatus 100.

The information processing apparatus 100 includes a first media sensor 111, a second media sensor 112, a feed roller 113, a separation roller 114, a third media sensor 115, an ultrasonic sensor 116, a first conveyance roller 117, a second conveyance roller 118, a fourth media sensor 119, an imaging device 120, a first ejection roller 121, and a second ejection roller 122 along the conveying path.

The number of each of the feed roller 113, the separation roller 114, the first conveyance roller 117, the second conveyance roller 118, the first ejection roller 121, and/or the second ejection roller 122 is not limited to one but may be two or more. When the feed roller 113, the separation roller 114, the first conveyance roller 117, the second conveyance roller 118, the first ejection roller 121, and/or the second ejection roller 122 are formed of multiple rollers, the multiple rollers are located at intervals in the width direction A2.

The upper surface of the lower housing 101 forms a lower guide 101a for the medium conveying path, and the lower surface of the upper housing 102 forms an upper guide 102a for the medium conveying path. As illustrated in FIG. 2, the medium conveying path is a so-called straight path, and the vertical relative positions of the front side and the back side of a medium do not change between when the medium is fed from the media tray 103 and when the medium is ejected onto the ejection tray 104.

The first media sensor 111 is located above the upper guide 102a, that is, above the medium conveying path, and upstream from the feed roller 113 and the separation roller 114. The first media sensor 111 includes multiple infrared proximity sensors located at intervals in the width direction A2. Each infrared proximity sensor includes a light emitter and a light receiver and measures the distance to an object present at the position facing the infrared proximity sensor based on the time period from the irradiation to the reflection of infrared light. The light emitter emits light (infrared light) in a direction substantially parallel to the medium conveying direction A1 toward the receiving surface of the media tray 103 or the medium on the media tray 103. The light receiver receives the light emitted by the light emitter and reflected by the receiving surface of the media tray 103 or the medium on the media tray 103. The light receiver generates and outputs a first media signal that is an electrical signal corresponding to the time period from when the light emitter emits light to when the light receiver receives the light.

The second media sensor 112 is located upstream from the feed roller 113 and the separation roller 114. The second media sensor 112 includes a contact sensor and detects whether a medium is placed on the media tray 103. The value of the second media signal generated and output by the second media sensor 112 changes depending on whether a medium is placed on the media tray 103. The second media sensor 112 is not limited to the contact sensor but may be any other sensor such as an optical sensor that detects the presence of a medium.

The feed roller 113 and the separation roller 114 are an example of a feeder and an example of a separator, respectively. The feed roller 113 is located in the lower housing 101, separates the media on the media tray 103 one by one from the bottom, and sequentially feeds the media. The separation roller 114 is a so-called brake roller or retard roller, located in the upper housing 102, and faces the feed roller 113. The separation roller 114 separates a medium from the media on the media tray 103. The separation roller 114 is rotatable in the direction indicated by arrow A5 opposite to the rotation direction for feeding a medium (i.e., the medium feeding direction). Alternatively, the separation roller 114 is stoppable. Instead of the separation roller 114, a separation pad may be used.

The third media sensor 115 is located downstream from the nip between the feed roller 113 and the separation roller 114 and upstream from the first conveyance roller 117 and the second conveyance roller 118, and detects the leading end and the trailing end of the medium conveyed to the detection position thereof. The third media sensor 115 includes a light emitter, a light receiver, and a light guide. The light emitter and the light receiver are located on one side of the medium conveying path. The light guide faces the light emitter and the light receiver across the medium conveying path. For example, the light guide is a U-shaped prism. The light emitter is, for example, an LED and emits light toward the medium conveying path. The light receiver is, for example, a photodiode and receives light emitted from the light emitter and guided by the light guide. When a medium is present at the position facing the third media sensor 115, the light emitted from the light emitter is blocked by the medium, and the light receiver does not detect the light emitted from the light emitter. The light receiver generates and outputs a third media signal based on the intensity of the light received. The third media signal changes in signal value depending on whether a medium is present at the position of the third media sensor 115.

The light guide may be substituted by a reflector, such as a mirror. The light emitter and the light receiver may be located to face each other across the conveying path. Further, the third media sensor 115 may detect the presence of the medium with, for example, a contact sensor that allows a predetermined amount of electrical current to flow when a medium is in contact or not in contact therewith.

The ultrasonic sensor 116 is located downstream from the feed roller 113 and the separation roller 114 and upstream from the first conveyance roller 117 and the second conveyance roller 118. The ultrasonic sensor 116 includes an ultrasonic transmitter 116a and an ultrasonic receiver 116b. The ultrasonic transmitter 116a and the ultrasonic receiver 116b are located near the medium conveying path and face each other across the medium conveying path. The ultrasonic transmitter 116a transmits ultrasonic waves. The ultrasonic receiver 116b receives the ultrasonic waves transmitted by the ultrasonic transmitter 116a and passed through a medium, and generates and outputs an ultrasonic signal which is an electrical signal corresponding to the received ultrasonic waves.

The first conveyance roller 117 and the second conveyance roller 118 are examples of a conveyor. The first conveyance roller 117 and the second conveyance roller 118 are located downstream from the feed roller 113 and the separation roller 114 in the medium conveying direction A1 and face each other. The first conveyance roller 117 and the second conveyance roller 118 convey the medium fed by the feed roller 113 and the separation roller 114 to the imaging device 120.

The fourth media sensor 119 is located downstream from the first conveyance roller 117 and the second conveyance roller 118 and upstream from the imaging device 120, and detects the leading end and the trailing end of the medium conveyed to the detection position thereof. The fourth media sensor 119 includes a light emitter, a light receiver, and a light guide. The light emitter and the light receiver are located on one side of the medium conveying path. The light guide faces the light emitter and the light receiver across the medium conveying path. For example, the light guide is a U-shaped prism. The light emitter is, for example, an LED and emits light toward the medium conveying path. The light receiver is, for example, a photodiode and receives light emitted from the light emitter and guided by the light guide. When a medium is present at the position facing the fourth media sensor 119, the light emitted from the light emitter is blocked by the medium, and the light receiver does not detect the light emitted from the light emitter. The light receiver generates and outputs a fourth media signal based on the intensity of the light received. The fourth media signal changes in signal value depending on whether a medium is present at the position of the fourth media sensor 119.

The light guide may be substituted by a reflector, such as a mirror. The light emitter and the light receiver may be located to face each other across the conveying path. Further, the fourth media sensor 119 may detect the presence of the medium with, for example, a contact sensor that allows a predetermined amount of electrical current to flow when a medium is in contact or not in contact therewith.

The imaging device 120 images the medium conveyed by the first conveyance roller 117 and the second conveyance roller 118. The imaging device 120 includes a first imaging device 120a and a second imaging device 120b facing each other across the medium conveying path.

The first imaging device 120a includes an imaging sensor that is a unity-magnification contact image sensor (CIS). The CIS includes complementary metal oxide semiconductor (CMOS) imaging elements aligned linearly in the main scanning direction. The first imaging device 120a further includes a lens that forms an image on the imaging elements and an analog-to-digital (A/D) converter. The A/D converter amplifies the electrical signals output from the imaging elements and performs analog-to-digital (A/D) conversion. The first imaging device 120a images the front side of the medium being conveyed, generates input images sequentially, and outputs the input images.

Similarly, the second imaging device 120b includes an imaging sensor that is a unity-magnification CIS including CMOS imaging elements aligned linearly in the main scanning direction. The second imaging device 120b further includes a lens that forms an image on the imaging elements and an A/D converter. The A/D converter amplifies the electrical signals output from the imaging elements and performs A/D conversion. The second imaging device 120b images the back side of the medium being conveyed, generates input images sequentially, and outputs the input images.

The imaging device 120 monitors whether the imaging device 120 has a hardware malfunction and outputs an error signal to the processing circuit when a hardware malfunction in the imaging device 120 is detected. The information processing apparatus 100 may include either the first imaging device 120a or the second imaging device 120b to read only one side of the medium. The imaging sensor may be a line sensor that employs a unity-magnification CIS including charge-coupled device (CCD) imaging elements. Alternatively, the imaging sensor may be a reduction-optical line sensor including CMOS or CCD imaging elements.

The first ejection roller 121 and the second ejection roller 122 are examples of an ejector. The first ejection roller 121 and the second ejection roller 122 are located downstream from the imaging device 120 and face each other. The first ejection roller 121 and the second ejection roller 122 eject the medium that is conveyed by the first conveyance roller 117 and the second conveyance roller 118 and is imaged by the imaging device 120 to the ejection tray 104.

The media placed on the media tray 103 are conveyed between the lower guide 101a and the upper guide 102a in the medium conveying direction A1 as the feed roller 113 rotates in the direction indicated by arrow A4 in FIG. 2, which is the medium feeding direction. The separation roller 114 rotates in the direction indicated by arrow A5 opposite to the medium feeding direction or is stopped when a medium is conveyed. When two or more media are placed on the media tray 103, only the medium in contact with the feed roller 113 is separated from the rest of the media on the media tray 103 due to the action of the feed roller 113 and the separation roller 114. This operation prevents the feeding of a medium other than the separated medium (prevention of multi-feed).

The medium is fed between the first conveyance roller 117 and the second conveyance roller 118 while being guided by the lower guide 101a and the upper guide 102a. The medium is fed between the first imaging device 120a and the second imaging device 120b as the first conveyance roller 117 and the second conveyance roller 118 rotate in the directions indicated by arrows A6 and A7, respectively. The medium read by the imaging device 120 is ejected onto the ejection tray 104 as the first ejection roller 121 and the second ejection roller 122 rotate in the directions indicated by arrows A8 and A9, respectively.

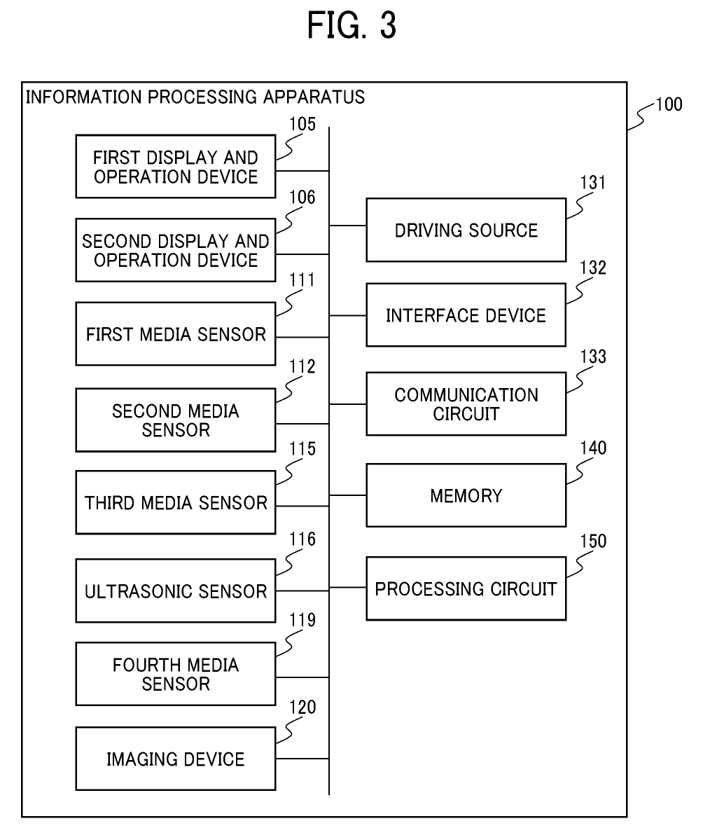

FIG. 3 is a block diagram illustrating a schematic configuration of the information processing apparatus 100.

The information processing apparatus 100 further includes a driving source 131, an interface device 132, a communication circuit 133, a memory 140, and a processing circuit 150 in addition to the above-described components.

The driving source 131 includes one or more motors. The driving source 131 generates a driving force for rotating the feed roller 113, the separation roller 114, the first conveyance roller 117, the second conveyance roller 118, the first ejection roller 121, and the second ejection roller 122 according to a control signal from the processing circuit 150. The driving source 131 is, for example, a direct-current motor. The driving source 131 may be a stepper motor. The second conveyance roller 118 and/or the second ejection roller 122 may be driven rollers rotated by the first conveyance roller 117 and the first ejection roller 121, respectively. Alternatively, the first conveyance roller 117 and/or the first ejection roller 121 may be driven rollers rotated by the second conveyance roller 118 and the second ejection roller 122, respectively. The driving source 131 monitors whether the driving source 131 has a hardware malfunction and outputs an error signal to the processing circuit 150 when a hardware malfunction in the driving source 131 is detected.

The interface device 132 is an example of a communication device. The interface device 132 includes an interface circuit that supports a serial bus, such as a universal serial bus (USB), and is electrically connected to an external device (e.g., a personal computer or a mobile information processing terminal) to transmit and receive input images and various kinds of information to and from the external device. The interface device 132 monitors whether the interface device 132 is connected to an external device via a cable. In other words, the interface device 132 monitors whether the cable is inserted into the information processing apparatus 100 and the external device or is pulled out from the information processing apparatus 100 or the external device. When the interface device 132 is connected to the external device via a cable, the interface device 132 determines that the interface device 132 is physically in communication with the external device. By contrast, when the interface device 132 is not connected to the external device via the cable, the interface device 132 determines that the interface device 132 is not physically in communication with the external device. The interface device 132 transmits a status signal indicating whether the interface device 132 is physically in communication with an external device to the processing circuit 150.

The communication circuit 133 is an example of a communication device. The communication circuit 133 includes an antenna that transmits and receives wireless signals, and a wireless communication interface circuit that transmits and receives signals through a wireless communication line in compliance with a given communication protocol. The given communication protocol is, for example, a wireless local area network (LAN) communication protocol. The communication circuit 133 is electrically connected to an external device (e.g., a personal computer, a mobile information processing terminal, or a server on a cloud network) to transmit and receive an input image and various kinds of information. The communication circuit 133 monitors whether wireless communication with an access point is established or disconnected. If wireless communication with an access point is established, the communication circuit 133 determines that the communication circuit 133 is physically in communication with the network. By contrast, when the wireless communication with the access point is disconnected, the communication circuit 133 determines that the communication circuit 133 is not physically in communication with the network. The communication circuit 133 transmits a status signal indicating whether the communication circuit 133 is physically in communication with the network to the processing circuit 150.

The communication circuit 133 may include a wired communication interface circuit to transmit and receive signals through a wired communication line in compliance with, for example, a wired LAN communication protocol. In this case, the communication circuit 133 monitors whether the communication circuit 133 is connected to or disconnected from the network. Specifically, the communication circuit 133 monitors whether the cable is inserted into the information processing apparatus 100 and a relay device, such as a switching hub or a repeater hub, or is pulled out from the information processing apparatus 100 or the relay device. When the communication circuit 133 is connected, the communication circuit 133 determines that the communication circuit 133 is physically in communication with the network. By contrast, when the communication circuit 133 is disconnected, the communication circuit 133 determines that the communication circuit 133 is not physically in communication with the network. The communication circuit 133 transmits a status signal indicating whether the communication circuit 133 is physically in communication with the network to the processing circuit 150.

The memory 140 includes memories such as a random-access memory (RAM) and a read-only memory (ROM), a fixed disk device such as a hard disk, a portable memory such as a flexible disk or an optical disk, etc. The memory 140 stores data such as computer programs, databases, and tables used for various processes performed by the information processing apparatus 100. The computer programs may be installed in the memory 140 from a computer-readable portable recording medium using, for example, a setup program. The portable recording medium is, for example, a compact disc-read-only memory (CD-ROM) or a digital versatile disc read-only memory (DVD-ROM). The computer programs may be distributed from, for example, a server and installed in the memory 140.

The processing circuit 150 operates according to a program prestored in the memory 140. The processing circuit is, for example, a central processing unit (CPU). Alternatively, a digital signal processor (DSP), a large-scale integration (LSI), an application-specific integrated circuit (ASIC), or a field-programmable gate array (FPGA) may be used as the processing circuit 150.

The processing circuit 150 is connected to the first display and operation device 105, the second display and operation device 106, the first media sensor 111, the second media sensor 112, the third media sensor 115, the ultrasonic sensor 116, the fourth media sensor 119, the imaging device 120, the driving source 131, the interface device 132, the communication circuit 133, the memory 140, etc., and controls these components. The processing circuit 150 controls operations such as the driving of the driving source 131 and the imaging by the imaging device 120 based on the media signals obtained from the media sensors. The processing circuit 150 obtains an input image from the imaging device 120 and transmits the input image to the information processing apparatus via the interface device 132 or the communication circuit 133.

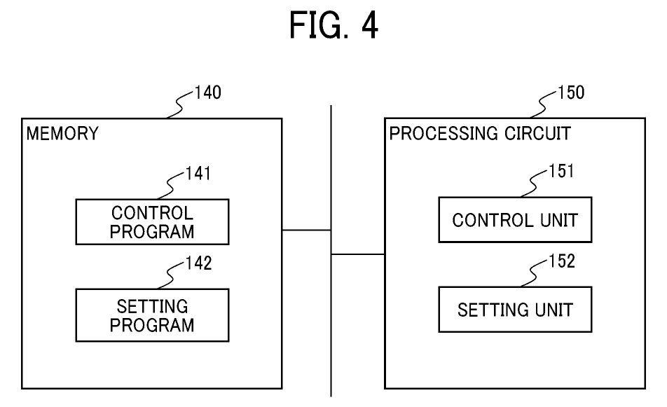

FIG. 4 is a block diagram illustrating schematic configurations of the memory 140 and the processing circuit 150.

As illustrated in FIG. 4, the memory 140 stores a control program 141 and a setting program 142. These programs are functional modules implemented by software that operates on the processor. The processing circuit 150 reads the programs from the memory 140 and operates according to the read programs. Thus, the processing circuit 150 functions as a control unit 151 and a setting unit 152.

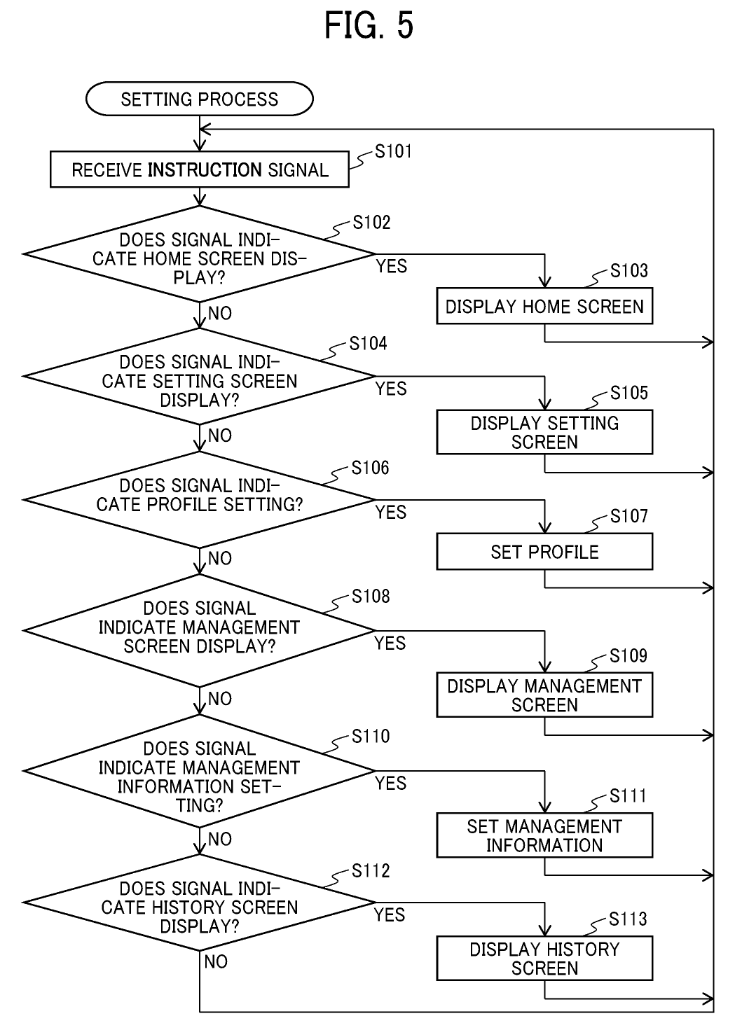

FIG. 5 is a flowchart of a setting process performed by the information processing apparatus 100.

The setting process performed by the information processing apparatus 100 is described below with reference to the flowchart of FIG. 5. The process described below is executed, for example, by the processing circuit 150 in cooperation with the components of the information processing apparatus 100 based on the programs prestored in the memory 140.

In step S101, the control unit 151 stands by until an instruction signal indicating an input instruction relating to the settings of the information processing apparatus 100 is received from the second display and operation device 106. The instruction is input by a user using the second display and operation device 106.

In step S102, the control unit 151 determines whether the received instruction signal indicates the display of a home screen. When a home screen selection button is pressed on a screen such as a setting screen, a management screen, or a history screen described later, the second display and operation device 106 outputs an instruction signal indicating the display of the home screen.

When the instruction signal indicates the display of the home screen (Yes in step S102), in step S103, the control unit 151 generates home screen display data for displaying the home screen, outputs the home screen display data to the second display and operation device 106, controls the second display and operation device 106 to display the home screen, and returns the process to step S101.

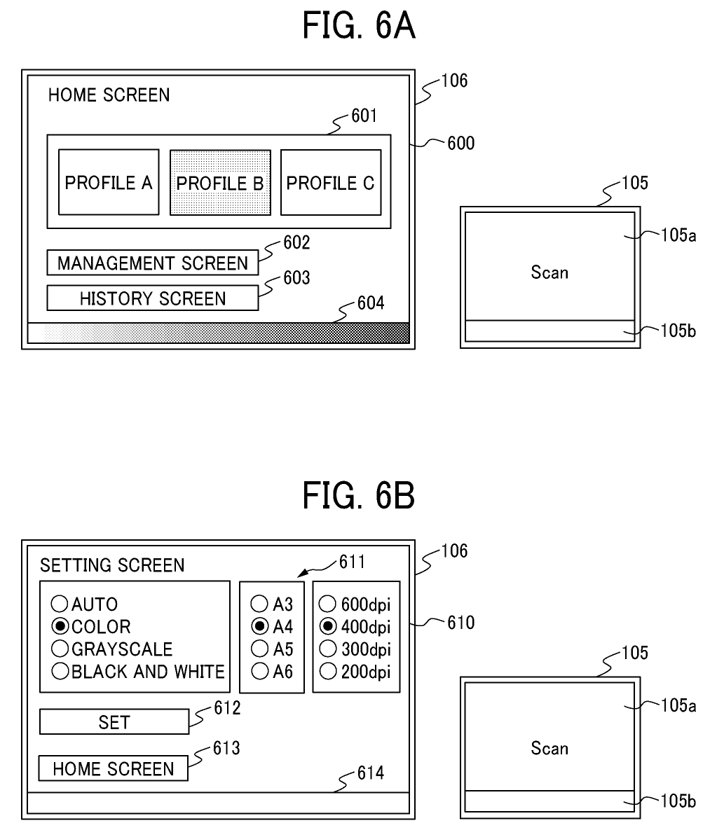

FIG. 6A is a schematic diagram illustrating the first display and operation device 105 and the second display and operation device 106 displaying a home screen 600.

The home screen 600 is an initial screen displayed when the information processing apparatus 100 is activated. As illustrated in FIG. 6A, the home screen 600 includes a designation object 601, a management screen selection button 602, a history screen selection button 603, and a guidance display object 604. The designation object 601 is an object for the user to designate a profile. The user can designate or set any of the profiles included in the designation object 601. When any one of the profiles included in the designation object 601 is designated by the user, the control unit 151 sets the designated profile in the memory 140. When the user instructs to set any of the profiles included in the designation object 601, the control unit 151 displays a setting screen on the second display and operation device 106. The management screen selection button 602 is a button for displaying the management screen on the second display and operation device 106. The history screen selection button 603 is a button for displaying a history screen on the second display and operation device 106. The guidance display object 604 is an object for displaying a guide that guides the user's line of sight to the first display and operation device 105.

The first display and operation device 105 includes an operation portion 105a and a display portion 105b. The operation portion 105a is a mechanical button, and the display portion 105b is an LED. In the example illustrated in FIG. 6A, the operation portion 105a and the display portion 105b are separate. Alternatively, the operation portion 105a and the display portion 105b may be integral with each other.

By contrast, when the instruction signal does not indicate the display of the home screen (No in step S102), the control unit 151 determines whether the instruction signal indicates the display of a setting screen in step S104. When the user instructs to set any of the profiles included in the designation object 601 on the home screen 600, the second display and operation device 106 outputs an instruction signal indicating the display of a setting screen. For example, when the selected profile is touched or held down for a certain period, the second display and operation device 106 determines that the setting of the profile is instructed.

When the instruction signal indicates the display of the setting screen (Yes in step S104), in step S105, the control unit 151 generates setting screen display data for displaying the setting screen, outputs the setting screen display data to the second display and operation device 106, and controls the second display and operation device 106 to display the setting screen. Then, the process is returned to step S101.

FIG. 6B is a schematic diagram illustrating the first display and operation device 105 and the second display and operation device 106 displaying a setting screen 610.

The setting screen 610 is a screen for the user to set each setting item included in a profile. The profile represents the settings on imaging processing or image processing that can be specified by a user depending on, for example, the use of the input image or the type of medium to be imaged. The profile includes a setting value for each setting item related to imaging processing or image processing. The setting items related to imaging processing include color, medium size, and resolution. The setting items related to image processing include orientation correction, edge correction, optical character recognition (OCR), and the transmission destination of an input image. As illustrated in FIG. 6B, the setting screen 610 includes a designation object 611, a setting button 612, a home screen selection button 613, and a guidance display object 614. The designation object 611 is an object for the user to designate a setting value for each setting item included in a profile. The setting button 612 is a button for setting the setting value designated in the designation object 611 in the information processing apparatus 100. The home screen selection button 613 is a button for displaying the home screen 600 on the second display and operation device 106. The guidance display object 614 is an object similar to the guidance display object 604.

By contrast, when the instruction signal does not indicate the display of the setting screen (No in step S104), in step S106, the control unit 151 determines whether the instruction signal indicates the setting of a profile. When the setting button 612 is pressed on the setting screen 610, the second display and operation device 106 outputs an instruction signal indicating the setting of a profile. When the instruction signal indicates the setting of a profile, the instruction signal includes a setting value designated in the designation object 611 for each setting item.

When the instruction signal indicates the setting of a profile (Yes in step S106), in step S107, the setting unit 152 sets the profile by storing the setting value for each setting item included in the instruction signal in the memory 140, and returns the process to step S101.

By contrast, when the instruction signal does not indicate the setting of a profile (No in step S106), the control unit 151 determines whether the instruction signal indicates the display of the management screen in step S108. When the management screen selection button 602 is pressed on the home screen 600, the second display and operation device 106 outputs an instruction signal indicating the display of the management screen.

When the instruction signal indicates the display of the management screen (Yes in step S108), in step S109, the control unit 151 generates management screen display data for displaying the management screen, outputs the management screen display data to the second display and operation device 106, and controls the second display and operation device 106 to display the management screen. Then, the process is returned to step S101.

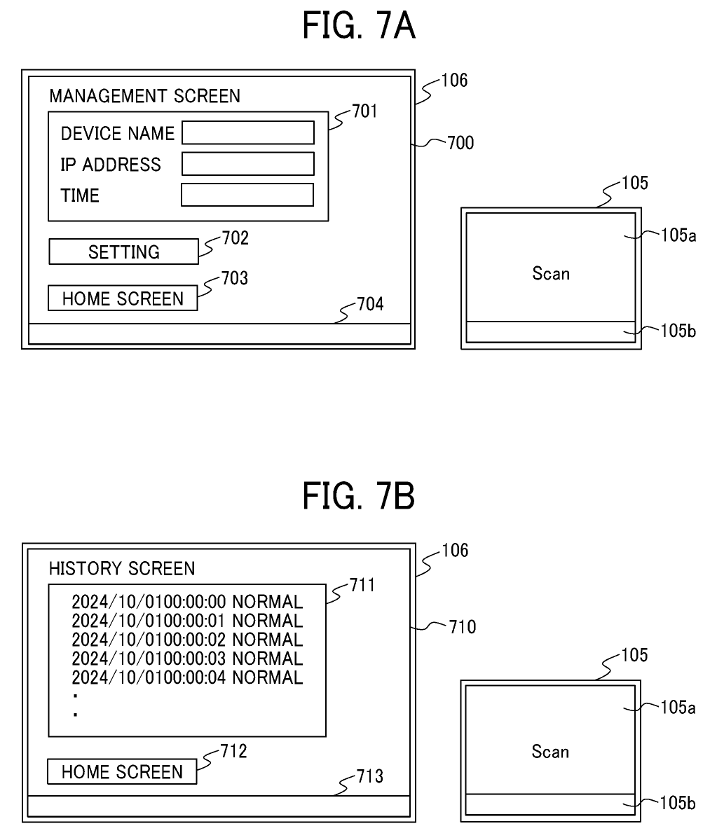

FIG. 7A is a schematic diagram illustrating the first display and operation device 105 and the second display and operation device 106 displaying a management screen 700.

The management screen 700 is a screen for the user to set management information. The management information includes the settings of the information processing apparatus 100 and network settings. For example, the management information includes an apparatus name, an internet protocol (IP) address, and time. As illustrated in FIG. 7A, the management screen 700 includes a designation object 701, a setting button 702, a home screen selection button 703, and a guidance display object 704. The designation object 701 is an object for designating management information. The setting button 612 is a button for setting the management information designated in the designation object 611 in the information processing apparatus 100. The home screen selection button 703 and the guidance display object 704 are objects similar to the home screen selection button 613 and the guidance display object 604, respectively.

When the instruction signal does not indicate the display of the management screen (No in step S108), in step S110, the control unit 151 determines whether the instruction signal indicates the setting of management information. When the setting button 702 is pressed on the management screen 700, the second display and operation device 106 outputs an instruction signal indicating the setting of management information. When the instruction signal indicates the management information setting instruction, the instruction signal includes the management information designated in the designation object 701.

When the instruction signal indicates the setting of management information (Yes in S110), in step S111, the setting unit 152 sets the management information included in the instruction signal in, for example, the memory 140, the communication circuit 133, and a time measurement device, and returns the process to step S101.

By contrast, when the instruction signal does not indicate the setting of management information (No in step S110), in step S112, the control unit 151 determines whether the instruction signal indicates the display of the history screen. When the history screen selection button 603 is pressed on the home screen 600, the second display and operation device 106 outputs an instruction signal indicating the display of the history screen.

When the instruction signal indicates the display of the history screen (Yes in step S112), in step S113, the control unit 151 generates history screen display data for displaying the history screen, outputs the history screen display data to the second display and operation device 106, and controls the second display and operation device 106 to display the history screen. Then, the process is returned to step S101.

FIG. 7B is a schematic diagram illustrating the first display and operation device 105 and the second display and operation device 106 displaying a history screen 710.

The history screen 710 is a screen for presenting the history of the predetermined process to the user. Specifically, the history is a history of the predetermined process executed by the information processing apparatus 100, and includes time and a processing result (e.g., normal or error). The history may include data (input image) obtained through the predetermined process. As illustrated in FIG. 7B, the history screen 710 includes a history object 711, a home screen selection button 712, and a guidance display object 713. The history object 711 is an object in which a history is displayed. The home screen selection button 712 and the guidance display object 713 are objects similar to the home screen selection button 613 and the guidance display object 604, respectively.

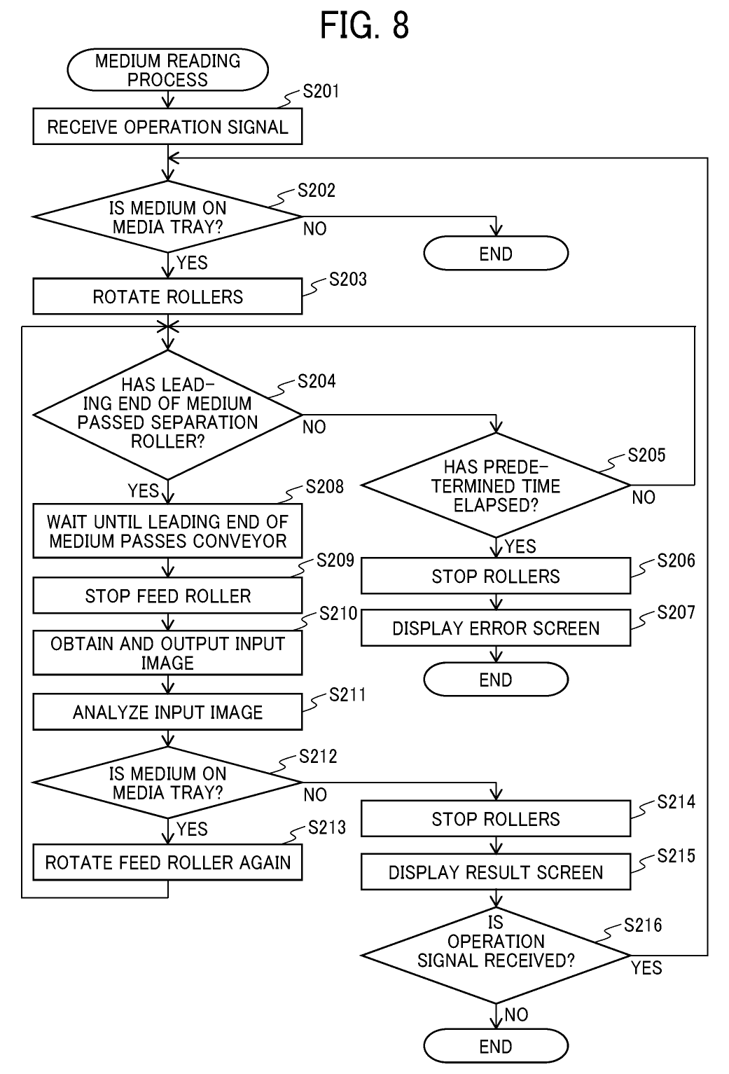

FIG. 8 is a flowchart of a medium reading process performed by the information processing apparatus 100.

The medium reading process performed by the information processing apparatus 100 is described below with reference to the flowchart of FIG. 8. The process described below is executed, for example, by the processing circuit 150 in cooperation with the components of the information processing apparatus 100 based on the programs prestored in the memory 140.

In step S201, the control unit 151 stands by until an operation signal instructing the reading of a medium is received from the first display and operation device 105. The operation signal is output when a user inputs an instruction to read the medium using the first display and operation device 105.

In step S202, the control unit 151 obtains a second media signal from the second media sensor 112 and determines whether a medium is placed on the media tray 103 based on the obtained second media signal. The control unit 151 ends the medium reading process when no medium is placed on the media tray 103.

By contrast, when a medium or media are placed on the media tray 103 (Yes in step S202), the control unit 151 controls the driving source 131 to rotate the rollers to convey the media in step S203. The control unit 151 sets the parameters such as the rotation speed of the driving source 131 so that an input image according to the profile stored (set) in the memory 140 is generated. The control unit 151 rotates the driving source 131 to rotate the feed roller 113, the separation roller 114, the first conveyance roller 117, the second conveyance roller 118, the first ejection roller 121, and/or the second ejection roller 122 in the directions indicated by arrows A4 to A9 in FIG. 2, respectively.

In step S204, the control unit 151 determines whether the leading end of the medium has passed the separator. The control unit 151 periodically obtains the third media signal from the third media sensor 115, and determines whether the medium is present at the position of the third media sensor 115 based on the obtained third media signal. When the signal value of the third media signal changes from the value indicating the absence of a medium to the value indicating the presence of a medium, the control unit 151 determines that the leading end of the medium has passed the position of the third media sensor 115, that is, the leading end of the medium has passed the separator.

When the leading end of the medium has not yet passed the separator (No in step S204), in step S205, the control unit 151 determines whether a predetermined time has elapsed since the start of feeding of the medium. The predetermined time is set in advance to a time period with which it is determined that a conveyance error such as jamming of the medium (paper jam) has occurred and the medium is not properly fed. When the predetermined time has not elapsed since the start of feeding of the medium (No in step S205), the control unit 151 returns the process to step S204 and repeats the process of steps S204 to S205.

By contrast, when the predetermined time has elapsed since the start of feeding of the medium (Yes in step S205), in step S206, the control unit 151 determines that a conveyance error such as jamming of the medium has occurred and controls the driving source 131 to stop the rollers. The control unit 151 stops the driving source 131 to stop the feed roller 113, the separation roller 114, the first conveyance roller 117, the second conveyance roller 118, the first ejection roller 121, and/or the second ejection roller 122.

In step S207, the control unit 151 generates error screen display data for displaying an error screen, outputs the error screen display data to the second display and operation device 106, controls the second display and operation device 106 to display the error screen, and ends the medium reading process.

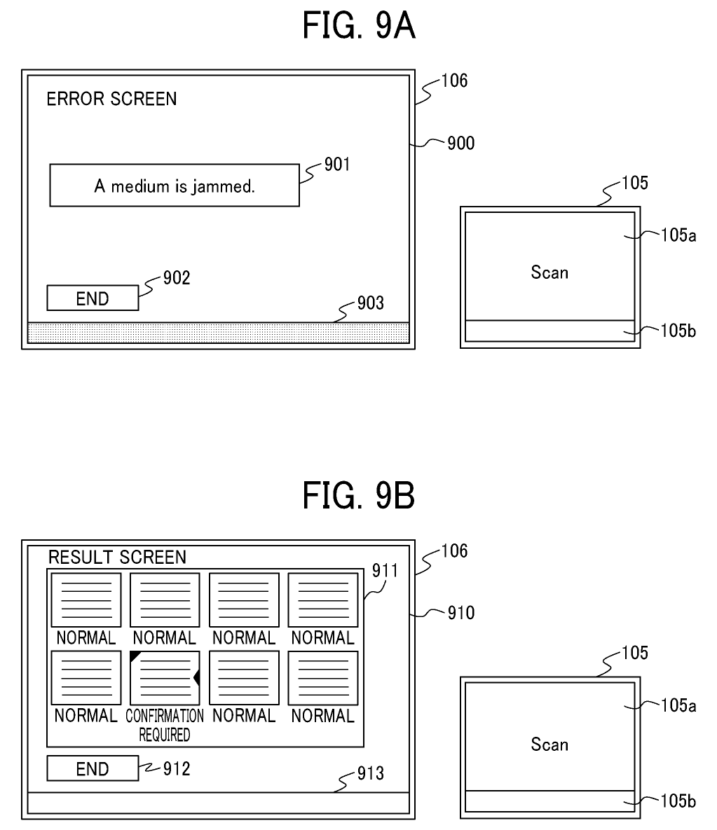

FIG. 9A is a schematic diagram illustrating the first display and operation device 105 and the second display and operation device 106 displaying an error screen 900.

The error screen 900 is a screen for notifying the user of the occurrence of an error in conveying a medium. As illustrated in FIG. 9A, the error screen 900 includes an error object 901, an end button 902, and a guidance display object 903. The error object 901 is an object for indicating the occurrence of an error in conveying a medium. The error object 901 may include the type of the error in conveying a medium (e.g., jam or multi-feed). When the end button 902 is pressed, the display of the error screen 900 is ended, and the home screen 600 is displayed. The guidance display object 903 is an object similar to the guidance display object 604. The guidance display object 903 is in a predetermined color (for example, yellow), indicating the occurrence of an error on the error screen 900.

In addition, when an error occurs in conveying a medium, the control unit 151 changes the display color of the display portion 105b of the first display and operation device 105 to a color (for example, yellow) different from the display color (for example, white) when no error occurs in conveying a medium. Accordingly, the user can accurately recognize that an error has occurred in conveying a medium, and the information processing apparatus 100 enhances the convenience of the user.

By contrast, when the leading end of the medium has passed the separator (Yes in step S204), in step S208, the control unit 151 waits until the leading end of the medium passes the conveyor. The control unit 151 periodically obtains the fourth media signal from the fourth media sensor 119, and determines whether the medium is present at the position of the fourth media sensor 119 based on the obtained fourth media signal. When the signal value of the fourth media signal changes from the value indicating the absence of a medium to the value indicating the presence of a medium, the control unit 151 determines that the leading end of the medium has passed the position of the fourth media sensor 119, that is, the leading end of the medium has passed the conveyor.

In step S209, the control unit 151 controls the driving source 131 to stop the feed roller 113. After that, the medium is conveyed by the first conveyance roller 117 and the second conveyance roller 118, and the feed roller 113 is rotated by the medium conveyed. The control unit 151 can prevent the medium from being pushed by the feed roller 113 and bent between the separator and the conveyor, resulting in jamming, by stopping the feed roller 113.

In step S210, the control unit 151 controls the imaging device 120 to image the conveyed medium to obtain an input image. The control unit 151 sets the parameters such as the imaging timing, and the imaging range of the imaging device 120 so that an input image according to the profile stored (set) in the memory 140 is generated. The control unit 151 transmits (i.e., outputs) the obtained input image to the transmission destination stored in the memory 140 via the interface device 132 or the communication circuit 133.

In step S211, the control unit 151 analyzes the obtained input image and determines whether the input image includes an abnormality of the medium. The control unit 151 stores the determination result in the memory 140.

For example, the control unit 151 determines whether the input image includes a fold or a chip of the medium as an abnormality of the medium. The control unit 151 calculates, for each pixel in the input image, the absolute value of the difference in pixel value between pixels adjacent on both sides in each of the horizontal direction and the vertical direction. This absolute value is referred to as an adjacent difference value in the following description. The control unit 151 then extracts the pixel as an edge pixel when the adjacent difference value exceeds a pixel value threshold. The pixel value is a brightness value or a color value, such as an R value, a G value, or a B value. The pixel value threshold is set to, for example, a difference in brightness value (e.g., 20) at which a person visually perceives a difference in brightness in an image. Alternatively, the control unit 151 may calculate, as the adjacent difference value, the absolute value of the difference in pixel value between two pixels apart by a predetermined distance from the target pixel in the input image. The control unit 151 may detect an edge pixel by comparing the pixel value of each pixel in the input image with a threshold. For example, when the pixel value of a particular pixel is less than the threshold and the pixel value of a pixel adjacent to or apart by the predetermined distance from the particular pixel is equal to or greater than the threshold, the control unit 151 extracts the particular pixel as the edge pixel. The control unit 151 generates an edge image in which pixels corresponding to the extracted edge pixels are valid pixels and pixels not corresponding to the edge pixels are invalid pixels.

Subsequently, the control unit 151 detects multiple straight lines from the generated edge image using the Hough transformation. The control unit 151 may detect the straight lines using the least squares method. The control unit 151 extracts all combinations of two horizontal straight lines and two vertical straight lines from all the extracted straight lines. The control unit 151 detects a rectangle candidate having the largest area among the rectangle candidates formed by the extracted combinations as a circumscribed rectangle of the medium. The control unit 151 groups the edge pixels adjacent to each other in the edge image by labeling, and detects a region surrounded by the edge pixels included in a group having the largest area among the groups as the medium region. The control unit 151 calculates a subtraction value by subtracting the area (the number of pixels) of the medium region from the area (the number of pixels) of the circumscribed rectangle. The control unit 151 determines that the input image includes a fold or a chip of the medium when the calculated subtraction value is equal to or greater than an area threshold, and determines that the input image does not indicate a fold or a chip of the medium when the subtraction value is smaller than the area threshold.

The control unit 151 may determine whether the input image includes an accumulated skew of the medium as an abnormality of the medium. The accumulated skew is a skew in which the tilt of the medium being conveyed changes, that is, a skew in which the medium rotationally moves. The control unit 151 calculates the angle formed by each of the horizontal straight lines corresponding to the upper side and the lower side of the circumscribed rectangle of the medium and each of the horizontal straight lines corresponding to the ruled lines inside the circumscribed rectangle. The control unit 151 further calculates the angle formed by each of the vertical straight lines corresponding to the left side and the right side of the circumscribed rectangle of the medium and each of the vertical straight lines corresponding to the ruled lines inside the circumscribed rectangle. The control unit 151 determines that the input image includes an accumulated skew of the medium when any of the calculated angles is equal to or greater than an angle threshold, and determines that the input image does not include an accumulated skew of the medium when any of the calculated angles is smaller than the angle threshold.

The control unit 151 may determine whether the input image includes a distortion or a wrinkle of the medium as an abnormality of the medium. The control unit 151 extracts pixels having a brightness value equal to or greater than a brightness threshold among the pixels in the medium region as pixels indicating the ground color (background) of the medium, and calculates a variance value of the brightness values of the extracted pixels. The control unit 151 determines that the input image includes a distortion or a wrinkle of the medium when the calculated variance value is equal to or greater than a variance threshold, and determines that the input image does not include a distortion or a wrinkle when the calculated variance value is less than the variance threshold.

In step S212, the control unit 151 determines whether a medium remains on the media tray 103 based on the second media signal received from the second media sensor 112.

When a medium remains on the media tray 103 (Yes in step S212), the control unit 151 controls the driving source 131 to rotate the feed roller 113 to feed and convey the medium in step S213. Subsequently, the control unit 151 returns the process to step S204 and repeats the process from step S204.

When no media remain on the media tray 103 (No in step S212), in step S214, the control unit 151 controls the driving source 131 to stop the rollers. The control unit 151 stops the driving source 131 to stop the separation roller 114, the first conveyance roller 117, the second conveyance roller 118, the first ejection roller 121, and/or the second ejection roller 122.

In step S215, the control unit 151 generates result screen display data for displaying a result screen, outputs the result screen display data to the second display and operation device 106, and controls the second display and operation device 106 to display the result screen.

FIG. 9B is a schematic diagram illustrating the first display and operation device 105 and the second display and operation device 106 displaying a result screen 910.

The result screen 910 is a screen for presenting the result of the medium reading process to the user. As illustrated in FIG. 9B, the result screen 910 includes a result object 911, an end button 912, and a guidance display object 913. The result object 911 is an object in which the result of the medium reading process is displayed. In the result object 911, for each conveyed medium, an input image (or a reduced image thereof) obtained by imaging the medium, and a determination result indicating whether the input image includes an abnormality of the medium are displayed. When the end button 912 is pressed, the display of the error screen 900 is ended, and the home screen 600 is displayed. The guidance display object 913 is an object similar to the guidance display object 604.

In step S216, the control unit 151 determines whether an operation signal is received from the first display and operation device 105 or an end instruction signal instructing the end of the medium reading process is received from the second display and operation device 106. When the user inputs an instruction to read a medium using the first display and operation device 105, the first display and operation device 105 outputs an operation signal to the control unit 151. By contrast, when the user presses the end button 912 on the second display and operation device 106, the second display and operation device 106 outputs an end instruction signal to the control unit 151. When the operation signal is received from the first display and operation device 105 (Yes in step S216), the control unit 151 returns the process to step S202 and repeats the process from step S202. By contrast, when the end instruction signal is received from the second display and operation device 106 (No in step S216), the control unit 151 ends the medium reading process.

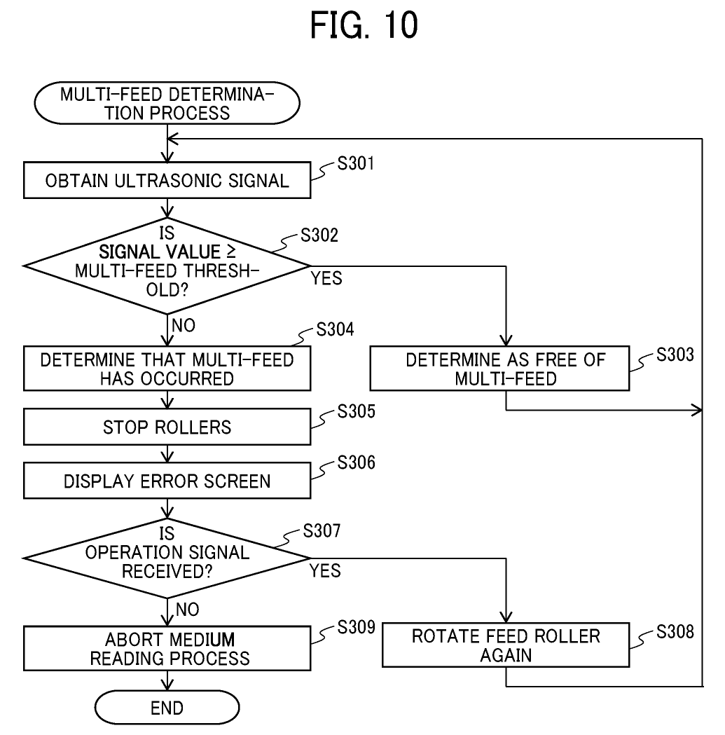

FIG. 10 is a flowchart of a multi-feed determination process performed by the information processing apparatus 100.

The multi-feed determination process performed by the information processing apparatus 100 is described below with reference to the flowchart of FIG. 10. The process described below is executed, for example, by the processing circuit 150 in cooperation with the components of the information processing apparatus 100 based on the programs prestored in the memory 140. The process illustrated in FIG. 10 is periodically executed in the conveyance of media.

In step S301, the control unit 151 obtains the ultrasonic signal from the ultrasonic sensor 116.

In step S302, the control unit 151 determines whether the signal value of the obtained ultrasonic signal is equal to or greater than the multi-feed threshold. The multi-feed threshold is set to a value between the value of the ultrasonic signal when one sheet is conveyed and the value of the ultrasonic signal when multi-feed is occurring.

When the signal value of the ultrasonic signal is equal to or greater than the multi-feed threshold (Yes in step S302), in step S303, the control unit 151 determines that the multi-feed of media has not occurred. Then, the process is returned to step S301.

By contrast, when the signal value of the ultrasonic signal is less than the multi-feed threshold (No in step S302), in step S304, the control unit 151 determines that the multi-feed of media has occurred.

In step S305, the control unit 151 controls the driving source 131 to stop the rollers. The control unit 151 stops the driving source 131 to stop the feed roller 113, the separation roller 114, the first conveyance roller 117, the second conveyance roller 118, the first ejection roller 121, and/or the second ejection roller 122.

In step S306, the control unit 151 generates error screen display data and outputs the error screen display data to the second display and operation device 106, and controls the second display and operation device 106 to display an error screen. The control unit 151 controls the second display and operation device 106 to display an error screen similar to the error screen 900 illustrated in FIG. 9. However, at this time, the error object 901 of the error screen 900 indicates that the multi-feed of media has occurred.

In step S307, the control unit 151 determines whether an operation signal is received from the first display and operation device 105 or an end instruction signal instructing the end of the medium reading process is received from the second display and operation device 106. When the user inputs an instruction to read a medium using the first display and operation device 105, the first display and operation device 105 outputs an operation signal to the control unit 151. By contrast, when the user presses the end button 902 on the second display and operation device 106, the second display and operation device 106 outputs an end instruction signal to the control unit 151.

When the operation signal is received from the first display and operation device 105 (Yes in step S307), in step S308, the control unit 151 controls the driving source 131 to rotate again the rollers stopped in step S305 and restart the feeding and conveying of media. Then, the process is returned to step S301.

By contrast, when the end instruction signal is received from the second display and operation device 106 (No in step S307), in step S309, the control unit 151 stops the medium reading process and ends the multi-feed determination process.

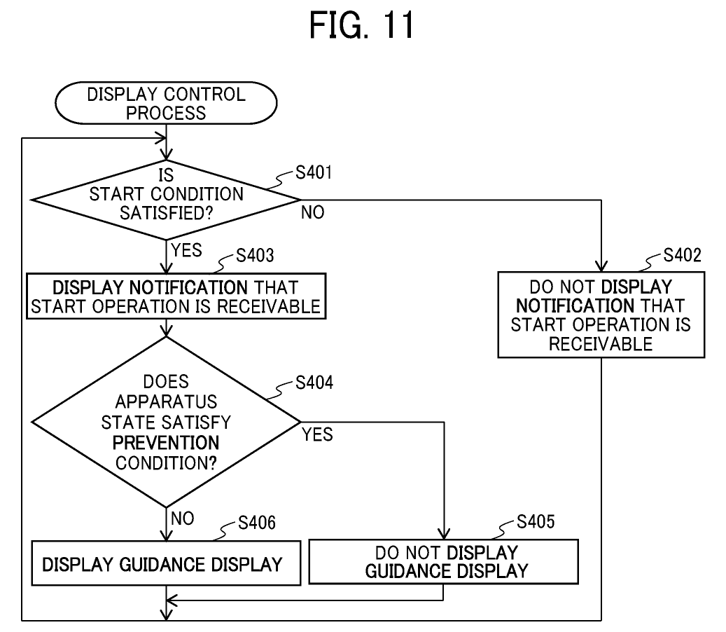

FIG. 11 is a flowchart of a display control process performed by the information processing apparatus 100.

The operations in the display control process performed by the information processing apparatus 100 is described below with reference to the flowchart of FIG. 11. The process described below is executed, for example, by the processing circuit 150 in cooperation with the components of the information processing apparatus 100 based on the programs prestored in the memory 140. The process illustrated in FIG. 11 is periodically executed after the apparatus is started.

In step S401, the control unit 151 determines whether the state of the apparatus satisfies a start condition for starting a predetermined process. The start condition is a condition for starting the predetermined process.

For example, the control unit 151 determines whether the state of the apparatus satisfies the start condition based on the screen displayed on the second display and operation device 106. The control unit 151 determines that the state of the apparatus does not satisfy the start condition when the management screen 700 is displayed on the second display and operation device 106, that is, when the user is setting the management information. By contrast, the control unit 151 determines that the state of the apparatus satisfies the start condition when the home screen 600, the setting screen 610, the history screen 710, the error screen 900, or the result screen 910 is displayed on the second display and operation device 106.

The control unit 151 may determine whether the state of the apparatus satisfies the start condition based on the screen displayed on the second display and operation device 106 and the content displayed on the screen. In this case, the control unit 151 determines that the state of the apparatus does not satisfy the start condition when the management screen 700 is displayed on the second display and operation device 106 and a rare profile is designated. The rare profile is a profile that has not been previously designated, or a profile for which the number of past designations is less than a number-of-times threshold. The number-of-times threshold is preliminarily determined. By contrast, the control unit 151 determines that the state of the apparatus satisfies the start condition when the management screen 700 is displayed on the second display and operation device 106 and a certain profile is designated. The certain profile is a profile that has been previously designated, or a profile for which the number of past designations is equal to or greater than the number-of-times threshold.

The control unit 151 may determine that the state of the apparatus does not satisfy the start condition when the error screen 900 is displayed on the second display and operation device 106 and an error, such as jamming of a medium is present. The error mentioned here is an error that allows the predetermined process to be executed but requires a recovery operation performed by the user. Further, the control unit 151 may determine that the state of the apparatus does not satisfy the start condition when the error screen 900 is displayed on the second display and operation device 106 and a serious error, such as a hardware malfunction is present. The serious error mentioned here is an error that makes the predetermined process inexecutable. When the control unit 151 receives an error signal from the imaging device 120 or the driving source 131, the control unit 151 determines that a hardware malfunction is present in, for example, the imaging device 120 or the driving source 131. By contrast, even when the error screen 900 is displayed on the second display and operation device 106, the control unit 151 may determine that the state of the apparatus satisfies the start condition when the error is a minor error, such as multi-feed of media, which allows the predetermined process to be executed (continued). When the result screen 910 is displayed on the second display and operation device 106, the control unit 151 may determine that the state of the apparatus satisfies the start condition regardless of whether any of one or more input images includes an abnormality of the medium, that is, regardless of whether a minor error that allows the predetermined process to be executed is present.

The control unit 151 may determine whether the state of the apparatus satisfies the start condition based on the situation of the apparatus related to the execution of the predetermined process. For example, the control unit 151 determines that the state of the apparatus does not satisfy the start condition when the designated profile is not usable, and determines that the state of the apparatus satisfies the start condition when the designated profile is usable. The control unit 151 determines whether the apparatus is in communication with the external device or the network, based on the status signal received from the interface device 132 or the communication circuit 133 that communicates with the transmission destination set in the designated profile. The control unit 151 determines that the designated profile is not usable when the apparatus is not in communication with the external device or the network, and determines that the designated profile is usable when the apparatus is in communication with the external device or the network.

When the state of the apparatus does not satisfy the start condition (No in step S401), in step S402, the control unit 151 does not control the first display and operation device 105 to display a notification display for notifying the user that the apparatus is ready to receive the start operation for the predetermined process (i.e., the start operation is receivable). Then, the process is returned to step S401.

By contrast, when the state of the apparatus satisfies the start condition (Yes in step S401), in step S403, the control unit 151 controls the first display and operation device 105 to display a notification display indicating that the start operation is receivable. For example, the control unit 151 controls the first display and operation device 105 to display the notification display by turning on the display portion 105b of the first display and operation device 105, and controls the first display and operation device 105 not to display the notification display by turning off the display portion 105b of the first display and operation device 105. Alternatively, the control unit 151 may control the first display and operation device 105 to perform the notification display by lighting the display portion 105b of the first display and operation device 105 in a first color (for example, blue). In this case, the control unit 151 controls the first display and operation device 105 not to display the notification display by lighting the display portion 105b of the first display and operation device 105 in a second color (for example, red) different from the first color. Alternatively, the control unit 151 may control the first display and operation device 105 to display the notification display by setting the brightness of the display portion 105b of the first display and operation device 105 to a first intensity. In this case, the control unit 151 sets the brightness of the display portion 105b of the first display and operation device 105 to a second intensity lower than the first intensity so that the first display and operation device 105 does not to display the notification display.

In this manner, when the state of the apparatus satisfies the start condition, the control unit 151 controls the first display and operation device 105 to display the notification display regardless of whether a prevention condition described later is satisfied. By contrast, when the state of the apparatus does not satisfy the start condition, the control unit 151 does not control the first display and operation device 105 to display the notification display regardless of whether the prevention condition described later is satisfied. In this manner, the first display and operation device 105, which is operated to start the predetermined process, allows the user to reliably recognize whether the predetermined process can be started. Thus, the information processing apparatus 100 enhances the convenience of the user.

In step S404, the control unit 151 determines whether the state of the apparatus satisfies the prevention condition for preventing the execution of the predetermined process. The prevention condition is a condition that is satisfied when a recommendation condition for recommending the start of the predetermined process is not satisfied. The recommended condition is a condition stricter than the start condition, and the start condition is a condition milder than the recommended condition.

For example, the control unit 151 determines whether the state of the apparatus satisfies the prevention condition based on the screen displayed on the second display and operation device 106. For example, the control unit 151 determines that the state of the apparatus does not satisfy the prevention condition when the home screen 600 is displayed on the second display and operation device 106, that is, when the apparatus waits for an instruction to read a medium from a user. Further, the control unit 151 determines that the state of the apparatus does not satisfy the prevention condition when the result screen 910 is displayed on the second display and operation device 106, that is, when the apparatus waits for an additional instruction to read a medium from the user. By contrast, the control unit 151 determines that the state of the apparatus satisfies the prevention condition when the setting screen 610, the management screen 700, the history screen 710, or the error screen 900 is displayed on the second display and operation device 106, that is, when the user sets a profile or management information or checks the history or an error. The control unit 151 may determine that the state of the apparatus does not satisfy the prevention condition in any of when the user is setting a profile, when the user is setting management information, when the user is checking a history, and when the user is checking an error.

As described above, the prevention condition includes a condition that a setting operation by the user is received. This allows the user to concentrate on the setting operation without being guided toward the first display and operation device 105 during the setting operation. Thus, the information processing apparatus 100 enhances the convenience of the user.

The prevention condition includes a condition that a history screen or an error screen is displayed. This allows the user to concentrate on checking the history or the error without being guided toward the first display and operation device 105 when the checking the history or the error. Thus, the information processing apparatus 100 enhances the convenience of the user.

The control unit 151 may determine whether the state of the apparatus satisfies the prevention condition based on the screen displayed on the second display and operation device 106 and the content displayed on the screen. For example, the control unit 151 determines that the state of the apparatus satisfies the prevention condition when the management screen 700 is displayed on the second display and operation device 106 and a rare profile is designated. The rare profile is a profile that has not been previously designated, or a profile for which the number of past designations is less than the number-of-times threshold. By contrast, the control unit 151 determines that the state of the apparatus does not satisfy the prevention condition when the management screen 700 is displayed on the second display and operation device 106 and a certain profile is designated. The certain profile is a profile that has been previously designated, or a profile for which the number of past designations is equal to or greater than the number-of-times threshold.

The control unit 151 may determine that the state of the apparatus satisfies the prevention condition when the error screen 900 is displayed on the second display and operation device 106 and an error, such as jamming of a medium, which allows the predetermined process to be executed but requires a recovery operation performed by the user, is present. Further, the control unit 151 may determine that the state of the apparatus satisfies the prevention condition when the error screen 900 is displayed on the second display and operation device 106 and a serious error, such as a hardware malfunction, which makes the predetermined process inexecutable, is present. The control unit 151 may determine that the state of the apparatus satisfies the prevention condition when the error screen 900 is displayed on the second display and operation device 106 and the error is a minor error, such as multi-feed of media, which allows the predetermined process to be executed (continued). The control unit 151 may determine that the state of the apparatus satisfies the prevention condition when the result screen 910 is displayed on the second display and operation device 106 and any of one or more input images includes an abnormality of the medium, that is, a minor error that allows the predetermined process to be executed is present. By contrast, when the result screen 910 is displayed on the second display and operation device 106 and no abnormality of the medium is included in the input images, the control unit 151 may determine that the state of the apparatus does not satisfy the prevention condition.

As described above, the prevention condition includes the occurrence of an abnormality. Accordingly, when an abnormality occurs, the user is not guided toward the first display and operation device 105 and is prevented from missing the occurrence of the abnormality. In particular, the prevention condition includes the occurrence of a minor abnormality that allows the predetermined process to be executed. Accordingly, when a minor abnormality occurs, the user is not guided toward the first display and operation device 105 and is prevented from missing the occurrence of the minor abnormality. Thus, the information processing apparatus 100 enhances the convenience of the user.

The control unit 151 may determine whether the state of the apparatus satisfies the prevention condition based on the situation of the apparatus related to the execution of the predetermined process. For example, the control unit 151 determines that the state of the apparatus satisfies the prevention condition when the designated profile is not usable, and determines that the state of the apparatus does not satisfy the prevention condition when the designated profile is usable. The control unit 151 determines whether the apparatus is in communication with the external device or the network, based on the status signal received from the interface device 132 or the communication circuit 133 that communicates with the transmission destination set in the designated profile. The control unit 151 determines that the designated profile is not usable when the apparatus is not in communication with the external device or the network, and determines that the designated profile is usable when the apparatus is in communication with the external device or the network.

Further, the control unit 151 may determine that the state of the apparatus satisfies the prevention condition when the medium is not properly placed on the media tray 103, and may determine that the state of the apparatus does not satisfy the prevention condition when the medium is properly placed on the media tray 103. The control unit 151 obtains a first media signal from the first media sensor 111 and determines the size and/or amount of media placed on the media tray 103 based on the first media signal. The control unit 151 calculates, for each of the infrared proximity sensors included in the first media sensor 111, the distance between the sensor and the position of reflection of the light emitted by the sensor based on the first media signal. The control unit 151 determines whether the light emitted by the sensor is reflected by the medium or the receiving surface depending on whether the calculated distance is equal to or less than a first threshold for each calculated distance. The control unit 151 determines, as the size of the medium placed on the media tray 103, the interval between the two outermost sensors in the width direction A2 among the sensors whose irradiation light is reflected from the medium. The control unit 151 determines that the medium is not properly placed on the media tray 103 when the determined size of the medium does not match the size of the medium set in the designated profile. By contrast, the control unit 151 determines that the medium is properly placed on the media tray 103 when the determined size of the medium matches the size of the medium set in the designated profile.

In addition, when the distance between any sensor and the position where the light emitted by the sensor is reflected is equal to or less than a second threshold, the control unit 151 determines that the amount of the medium (the height of the total media) placed on the media tray 103 exceeds the allowable amount. By contrast, when the distances calculated for all the sensors are larger than the second threshold, the control unit 151 determines that the amount of the media placed on the media tray 103 does not exceed the allowable amount. When the amount of the media placed on the media tray 103 exceeds the allowable amount, the control unit 151 determines that the media are not properly placed on the media tray 103. When the amount of the media placed on the media tray 103 does not exceed the allowable amount, the control unit 151 determines that the media are properly placed on the media tray 103.

Further, when no medium is placed on the media tray 103, the control unit 151 may determine that a medium is not properly placed on the media tray 103, and, when a medium is placed on the media tray 103, the control unit 151 may determine that the medium is properly placed on the media tray 103. In this case, the control unit 151 determines whether a medium is placed on the media tray 103 based on the second media signal received from the second media sensor 112.

When the state of the apparatus satisfies the prevention condition (Yes in step S404), in step S405, the control unit 151 does not control the second display and operation device 106 to display the guidance display for guiding the user's line of sight to the first display and operation device 105, and returns the process to step S401.

By contrast, when the state of the apparatus does not satisfy the prevention condition (No in step S404), in step S406, the control unit 151 controls the first display and operation device 105 to display the guidance display, and returns the process to step S401. The guidance display is an example of a predetermined display. The guidance display is displayed on a guidance display object on the second display and operation device 106. As illustrated in FIG. 6A, the guidance display is, for example, an animation oriented from the position of the second display and operation device 106 toward the position of the first display and operation device 105. For example, the guidance display is an animation in which light flows from the end of the second display and operation device 106 farther from the first display and operation device 105 toward the end closer to the first display and operation device 105. The control unit 151 makes the brightness of each horizontal position in the guidance display object on the second display and operation device 106 different. The control unit 151 controls the display of the guidance display object such that a bright region (or a dark region) in the guidance display object moves from the end of the second display and operation device 106 farther from the first display and operation device 105 toward the end closer to the first display and operation device 105. Accordingly, since the line of sight of the user viewing the second display and operation device 106 is guided from the position of the second display and operation device 106 toward the position of the first display and operation device 105, the user can operate the first display and operation device 105 in a natural and seamless manner to start reading the medium. Thus, the information processing apparatus 100 enhances the convenience of the user.

In this manner, when the state of the apparatus satisfies the start condition and does not satisfy the prevention condition, the control unit 151 controls the second display and operation device 106 to display the guidance display. This allows the user to operate the first display and operation device 105 to start the reading of the medium in a natural and seamless manner. Thus, the information processing apparatus 100 enhances the convenience of the user.

By contrast, when the state of the apparatus satisfies the start condition and the prevention condition, the control unit 151 does not control the second display and operation device 106 to display the guidance display. Accordingly, the user can concentrate on the current work, such as setting or confirmation and can be prevented from overlooking the occurrence of a minor abnormality. Thus, the information processing apparatus 100 enhances the convenience of the user.

As described in detail above, when the start condition for starting the predetermined process is satisfied and the prevention condition for preventing the execution of the predetermined process is not satisfied, the information processing apparatus 100 controls the second display and operation device 106 to display the predetermined display. Accordingly, the information processing apparatus 100 enhances the convenience of the user.

When the state of the apparatus satisfies the start condition, the information processing apparatus 100 controls the first display and operation device 105 to display a notification display to notify the user of whether the predetermined process can be started. Further, when the state of the apparatus does not satisfy the prevention condition, the information processing apparatus 100 controls the second display and operation device 106 to display the guidance display, thereby prompting the user to start the predetermined process. Accordingly, the user can accurately recognize the timing for performing the operation to start the predetermined process, and the information processing apparatus 100 enhances the convenience of the user.

The information processing apparatus 100 includes the first display and operation device 105 including a mechanical button, separately from the second display and operation device 106 including a touch screen. The user can flexibly perform an operation in a wide operation area on the touch screen when setting a profile or management information or checking a history or an error, and can reliably perform an operation using the mechanical button when starting a predetermined process. Thus, the information processing apparatus 100 enhances the ease of user operation.

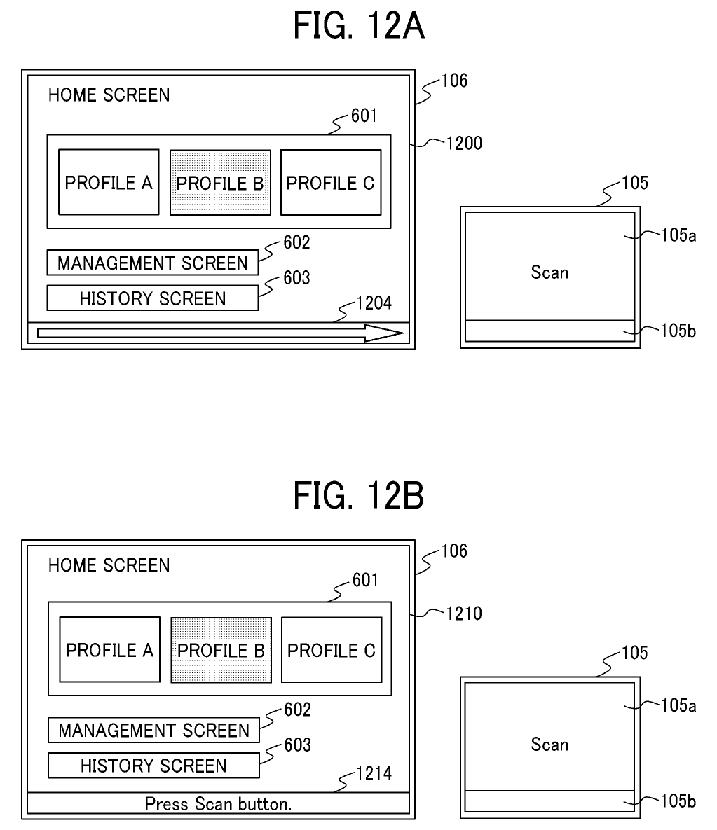

FIG. 12A is a schematic diagram illustrating another guidance display displayed by an information processing apparatus. FIG. 12A is a schematic diagram illustrating the first display and operation device 105 and the second display and operation device 106 displaying a home screen 1200.

As illustrated in FIG. 12A, the home screen 1200 displayed on the second display and operation device 106 includes a guidance display object 1204 instead of the guidance display object 604. The guidance display object 1204 is an object for displaying a guidance display that guides the user's line of sight to the first display and operation device 105, similarly to the guidance display object 604. The guidance display displayed on the guidance display object 1204 includes a graphic image oriented from the position of the second display and operation device 106 toward the position of the first display and operation device 105. The control unit 151 displays an arrow pointing in the direction from the second display and operation device 106 toward the first display and operation device 105 in the guidance display object 1204. Accordingly, since the line of sight of the user viewing the second display and operation device 106 is guided from the second display and operation device 106 toward the first display and operation device 105, the user can operate the first display and operation device 105 in a natural and seamless manner to start reading the medium. Thus, the information processing apparatus 100 enhances the convenience of the user.

As described above in detail, the information processing apparatus 100 enhances the convenience of the user also when the guidance display is the graphic display oriented from the position of the second display and operation device 106 toward the position of the first display and operation device 105.

FIG. 12B is a schematic diagram illustrating another guidance display displayed by an information processing apparatus. FIG. 12B is a schematic diagram illustrating the first display and operation device 105 and the second display and operation device 106 displaying a home screen 1210.

As illustrated in FIG. 12B, the home screen 1210 displayed on the second display and operation device 106 includes a guidance display object 1214 instead of the guidance display object 604. The guidance display object 1214 is an object for displaying a guidance display that guides the user's line of sight to the first display and operation device 105, similarly to the guidance display object 604. The guidance display displayed on the guidance display object 1214 includes a text that prompts the start of the predetermined process. The control unit 151 displays a message prompting the user to press the first display and operation device 105 in the guidance display object 1214. Accordingly, the line of sight of the user viewing the second display and operation device 106 is guided toward the first display and operation device 105 on which the operation to start the predetermined process is performed. Then, the user can operate the first display and operation device 105 in a natural and seamless manner to start reading the medium. Thus, the information processing apparatus 100 enhances the convenience of the user.

As described in detail above, the information processing apparatus 100 enhances the convenience of the user also when the guidance display includes the text prompting the start of the predetermined process.

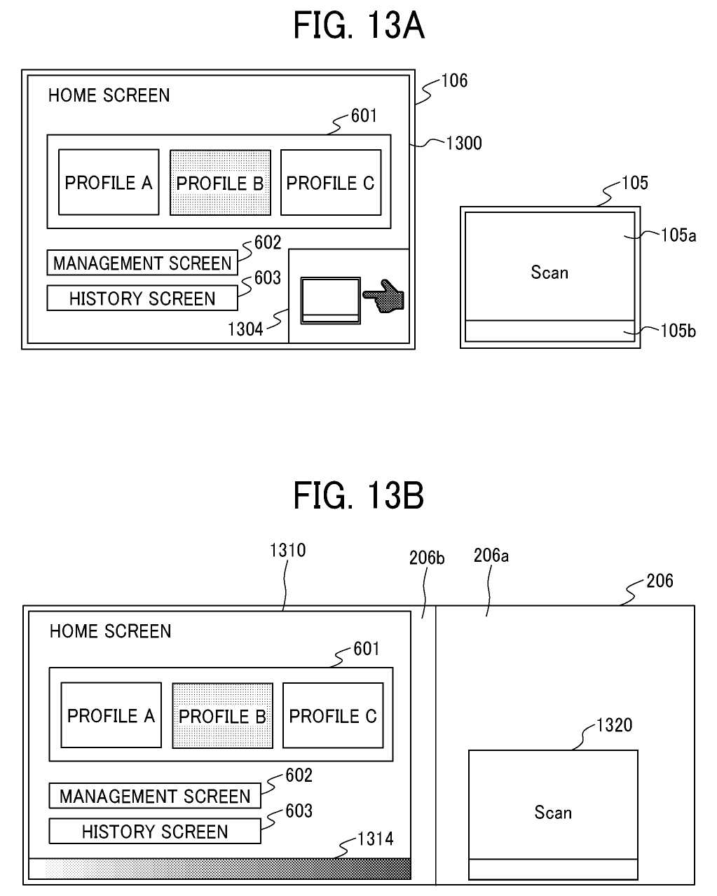

FIG. 13A is a schematic diagram illustrating another guidance display displayed by an information processing apparatus. FIG. 13A is a schematic diagram illustrating the first display and operation device 105 and the second display and operation device 106 displaying a home screen 1300.

As illustrated in FIG. 13A, the home screen 1300 displayed on the second display and operation device 106 includes a guidance display object 1304 instead of the guidance display object 604. The guidance display object 1304 is an object for displaying a guidance display that guides the user's line of sight to the first display and operation device 105, similarly to the guidance display object 604. The guidance display displayed on the guidance display object 1304 includes a graphic image that prompts the start of the predetermined process. The control unit 151 displays a graphic image prompting the user to press the first display and operation device 105 in the guidance display object 1214. Accordingly, the line of sight of the user viewing the second display and operation device 106 is guided toward the first display and operation device 105 on which the operation to start the predetermined process is performed. Then, the user can operate the first display and operation device 105 in a natural and seamless manner to start reading the medium. Thus, the information processing apparatus 100 enhances the convenience of the user.

As described above in detail, the information processing apparatus 100 enhances the convenience of the user also when the guidance display includes the graphic image prompting the start of the predetermined process.

FIG. 13B is a schematic diagram illustrating another guidance display displayed by an information processing apparatus. FIG. 13B is a schematic diagram illustrating a second display and operation device 206 displaying a home screen 1310.

In this case, the information processing apparatus has the configuration similar to the configuration of the information processing apparatus 100 illustrated in FIG. 3 except that the first display and operation device 105 is not included and the second display and operation device 106 is replaced with the second display and operation device 206. The second display and operation device 206 has a configuration and functions similar to those of the second display and operation device 106. The second display and operation device 206 includes an input device, such as a touch screen, and an interface circuit that receives signals from the input device. The second display and operation device 206 receives an operation input by the user and outputs a signal corresponding to the input operation.

As illustrated in FIG. 13B, the second display and operation device 206 includes a first area 206a and a second area 206b. The first area 206a of the second display and operation device 206 is an example of the first operation portion, and the second area 206b of the second display and operation device 206 is an example of a second operation portion. When the information processing apparatus does not include the first display and operation device 105, the number of components is reduced, and the apparatus cost can be reduced.

An operation button 1320 is displayed in the first area 206a. The operation button 1320 is a button for receiving the start operation and the end operation performed by the user for the predetermined process. The display mode of the operation button 1320 or the area around the operation button 1320 in the first area 206a is changed by changing the information displayed on the display according to an instruction from the control unit 151. The control unit 151 does not display the notification display in the first area 206a of the second display and operation device 206 in step S402 in FIG. 11, and displays the notification display in the first area 206a of the second display and operation device 206 in step S403 in FIG. 11. For example, the control unit 151 displays the notification display in the first area 206a by making the brightness of the operation button 1320 or the area around the operation button 1320 higher than the brightness of the other areas of the first area 206a. By contrast, the control unit 151 does not display the notification display in the first area 206a by not making the brightness of the operation button 1320 or the area around the operation button 1320 higher than the brightness of the other areas of the first area 206a.

In the second area 206b, a home screen 1310 is displayed. In the second area 206b, a setting screen, a management screen, a history screen, an error screen, or a result screen is also displayed. The home screen 1310 includes a guidance display object 1314 instead of the guidance display object 604. The guidance display object 1314 is an object for displaying a guidance display that guides the line of sight of the user to the first display and operation device 105, similarly to the guidance display object 604, 1204, 1214, or 1314. This allows the user to operate the first display and operation device 105 to start reading the medium in a natural and seamless manner. Thus, the information processing apparatus 100 enhances the convenience of the user.

The control unit 151 may change the area of the first area 206a and/or the second area 206b according to the state of the apparatus. For example, the control unit 151 increases the area of the first area 206a when the state of the apparatus satisfies the start condition but does not satisfy the prevention condition to be larger than the area of the first area 206a when the state of the apparatus satisfies both the start condition and the prevention condition. By contrast, the control unit 151 reduces the area of the second area 206b when the state of the apparatus satisfies the start condition but does not satisfy the prevention condition to be smaller than the area of the second area 206b when the state of the apparatus satisfies both the start condition and the prevention condition. The control unit 151 increases the area of the first area 206a when the state of the apparatus satisfies both the start condition and the prevention condition to be larger than the area of the first area 206a when the state of the apparatus does not satisfy the start condition. By contrast, the control unit 151 reduces the area of the second area 206b when the state of the apparatus satisfies both the start condition and the prevention condition to be smaller than the area of the second area 206b when the state of the apparatus does not satisfy the start condition. Accordingly, the user can accurately recognize the timing for performing the operation to start the predetermined process, and the information processing apparatus 100 enhances the convenience of the user.

As described above in detail, the information processing apparatus enhances the convenience of the user also when the guidance display and the object for receiving the start operation for the predetermined process are displayed on one display.

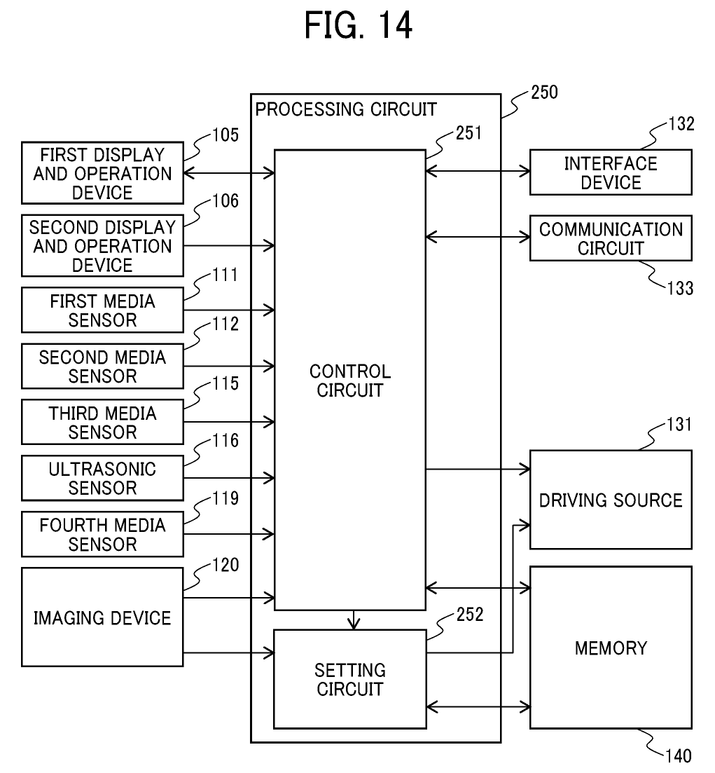

FIG. 14 is a diagram illustrating a schematic configuration of a processing circuit 250 in another information processing apparatus.

The processing circuit 250 is used instead of the processing circuit 150 and executes, for example, the setting process, the medium reading process, the multi-feed determination process, and the display control process instead of the processing circuit 150. The processing circuit 250 includes a control circuit 251 and a setting circuit 252. These circuits may be implemented by independent integrated circuits, microprocessors, firmware, or a combination thereof.

The control circuit 251 is one example of a control unit and functions like the control unit 151. The control circuit 251 receives the operation signal from the first display and operation device 105, the first media signal from the first media sensor 111, the second media signal from the second media sensor 112, the third media signal from the third media sensor 115, the ultrasonic signal from the ultrasonic sensor 116, and the fourth media signal from the fourth media sensor 119. The control circuit 251 controls the driving source 131 and the imaging device 120 based on the received information, obtains an input image from the imaging device 120, stores the input image in the memory 140, and outputs the input image to the interface device 132 or the communication circuit 133. The control circuit 251 receives an instruction signal from the second display and operation device 106, controls the display on the second display and operation device 106 according to the instruction indicated by the instruction signal, and outputs the instruction indicated by the instruction signal to the setting circuit 252.

The setting circuit 252 is one example of the setting unit and functions like the setting unit 152. The setting circuit 252 receives an instruction indicated by the instruction signal from the control circuit 251, and sets each item or management information included in the profile in the memory 140, the imaging device 120, or the driving source 131.

As described above in detail, the information processing apparatus using the processing circuit 250 also enhances the convenience of the user.

Embodiments of the present disclosure are not limited to the above-described embodiments. For example, when displaying the guidance display on the second display and operation device 106, the information processing apparatus may link the notification display displayed on the first display and operation device 105 with the guidance display displayed on the second display and operation device 106. For example, when the guidance display is an animation in which light flows from the end of the second display and operation device 106 farther from the first display and operation device 105 toward the end closer to the first display and operation device 105, the notification display may also be an animation in which light flows from the end of the first display and operation device 105 closer to the second display and operation device 106 toward the end farther from the second display and operation device 106. In that case, the control unit 151 controls the display such that the light flows in the first display and operation device 105 from the end closer to the second display and operation device 106 toward the opposite end when the light in the second display and operation device 106 reaches the end closer to the first display and operation device 105.

Additionally, the guidance display and the notification display may also be an animation in which the brightness of the second display and operation device 106 and that of the first display and operation device 105 change at the same or similar timing, or the second display and operation device 106 and the first display and operation device 105 blink. This enhances the sense of coordination between the first display and operation device 105 and the second display and operation device 106. Thus, the information processing apparatus can guide the user's line of sight to the first display and operation device 105 more strongly.

Further, the medium conveying path in the information processing apparatus may be a so-called U-turn path, and the medium placed on the media tray may be fed and conveyed sequentially from the top and ejected onto the ejection tray. In this configuration, the separation roller is located below the feed roller to face the feed roller. The information processing apparatus may be a flatbed apparatus that captures an image without conveying a medium.

The information processing apparatus may include an image forming device instead of or in addition to the imaging device 120. The image forming device employs, for example, an inkjet printing method or a laser printing method, is located at the position corresponding to the position of the imaging device 120, and forms an image (prints information) on a medium conveyed. In this case, the predetermined process is forming an image on a medium.

The information processing apparatus may be any information processing apparatus, such as a server, a personal computer, a smartphone, a mobile phone, or a printer. In this case, the predetermined process may be any process that is executed by a general-purpose computer.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising:
a first operation portion to receive a first operation to start a predetermined process;
a second operation portion to receive a second operation and to be controlled to change a display mode; and
control circuitry configured to control the second operation portion to display a predetermined display when a state of the information processing apparatus satisfies a start condition for starting the predetermined process and does not satisfy a prevention condition for preventing execution of the predetermined process.

2. The information processing apparatus according to claim 1,
wherein the predetermined display includes a guidance display that guides a line of sight of a user toward the first operation portion.

3. The information processing apparatus according to claim 1, wherein
the first operation portion is controlled to change a display mode,
when the state of the apparatus satisfies the start condition, the control circuitry is configured to control the first operation portion to display a notification display regardless of whether the prevention condition is satisfied, wherein the notification display is for notifying a user that the information processing apparatus is ready to receive the first operation to start the predetermined process, and
when the state of the apparatus does not satisfy the start condition, the control circuitry is configured to control the first operation portion not to display the notification display regardless of whether the prevention condition is satisfied.

4. The information processing apparatus according to claim 1,
wherein the control circuitry is configured to control the second operation portion not to display the predetermined display when the state of the information processing apparatus satisfies the start condition and the prevention condition.

5. The information processing apparatus according to claim 1, wherein
the first operation portion includes a mechanical button, and
the second operation portion includes a touch screen.

6. The information processing apparatus according to claim 1,
wherein the first operation portion includes a first area of a touch screen and the second operation portion includes a second area of the touch screen.

7. The information processing apparatus according to claim 1,
wherein the predetermined process includes reading of a medium.

8. The information processing apparatus according to claim 1,
wherein the prevention condition includes a condition that a setting operation by a user is received, a condition that a history screen or an error screen is displayed, or a condition that the information processing apparatus has an abnormality.

9. The information processing apparatus according to claim 1, wherein
the predetermined display includes:
an animation oriented from a position of the second operation portion toward a position of the first operation portion;
a text or a graphic image prompting to start the predetermined process; or
a graphic image oriented from the position of the second operation portion toward the position of the first operation portion.

10. An information processing method performed by an apparatus including a first operation portion that receives a first operation to start a predetermined process, and a second operation portion that receives a second operation and is controlled to change a display mode,
the information processing method comprising
controlling the second operation portion to display a predetermined display when a state of the apparatus satisfies a start condition for starting the predetermined process and does not satisfy a prevention condition for preventing execution of the predetermined process.

11. A computer-readable, non-transitory medium storing a computer program, wherein the computer program causes an information processing apparatus including a first operation portion that receives a first operation to start a predetermined process, and a second operation portion that receives a second operation and is controlled to change a display mode, to execute a process,
the process comprising
controlling the second operation portion to display a predetermined display when a state of the apparatus satisfies a start condition for starting the predetermined process and does not satisfy a prevention condition for preventing execution of the predetermined process.
